(19) United States
(12) Patent Application Publication
(10) Pub. No.: US 2017/0050620 A1
(43) Pub. Date: Feb. 23, 2017

(54) WINDSCREEN WIPER ARM

(71) Applicant: FEDERAL-MOGUL S.A., AUBANGE, MI (US)

(72) Inventor: THOMAS FRISCIONI, MEXY (FR)

(73) Assignee: FEDERAL-MOGUL S.A., AUBANGE, MI (US)

(21) Appl. No.: 15/307,479

(22) PCT Filed: May 1, 2014
(86) PCT No.: PCT/EP2014/058940

§ 371 Date: Oct. 28, 2016

(51) Int. Cl. B60S 1/34; B60S 1/40; B60S 1/52

(52) U.S. Cl. CPC B60S 1/345; B60S 1/524; B60S 1/4006; B60S 2001/3898

(57) ABSTRACT

A windscreen wiper arm (1), comprising a mounting head (2) mountable on a drive shaft (3) and a first arm member (4) at one end thereof being pivotally connected to the mounting head (2) by means of a pivot pin (8) and at another end thereof being rigidly connected to a second arm member (5) arranged to be connected to an elongated wiper blade (6) to be placed in abutment with the windscreen to be wiped. The first (4) and said second (5) arm members can oscillate to-and-from between a first reversal position and a second reversal position. The second arm member (5) is made in one piece and has a substantially U-shaped cross-section defining a housing between a base and legs of said U-shaped cross-section. The housing is arranged to accommodate at least one channel (14, 15) for a washing liquid and/or electricity wiring.

### BACKGROUND OF THE INVENTION

1. Technical Field

The present invention relates to a windscreen wiper arm, particularly for automobiles, comprising a mounting head mountable on a drive shaft and a first arm member at one end thereof being pivotally connected to the mounting head by means of a pivot pin and at another end thereof being rigidly connected to a second arm member arranged to be connected to an elongated wiper blade to be placed in abutment with the windscreen to be wiped, and wherein the first and the second arm members can oscillate to-and-from between a first reversal position and a second reversal position.

2. Related Art

In the framework of the present invention the first reversal position may be identified as a position, wherein the arm members extend parallel to a windscreen to be wiped and are located near a lower edge of the windscreen to be wiped. Also, the second reversal position may be formulated as a position, wherein the arm members extend also parallel to a windscreen to be wiped and are located in a central region or near a side edge of the windscreen to be wiped.

The present invention also relates to a vehicle equipped with such a windscreen wiper arm, as well as to a method for manufacturing a windscreen wiper arm.

It is noted that the present invention is not restricted to automobiles, but also refers to rail coaches and other (fast) vehicles.

Such a windscreen wiper arm is generally known. The first arm member at one end thereof is pivotally connected to the mounting head by means of a pivot pin, for example in the form of a rivet. The first arm member at the other end thereof is connected to a second arm member in the form of a wiper rod, wherein one end of the wiper rod extends inside the first arm member. A spring is hooked with its first end on the mounting head and with its second end on to the wiper rod in order to ensure that the wiper rod and thus the wiper blade connected thereto is pressed onto a windscreen to be wiped. In use, the shaft rotates alternately in a clockwise and in a counter-clockwise sense carrying the mounting head into rotation also, which in turn draws the arm members into rotation and by means of a connecting device (interconnecting the wiper rod and the wiper blade) moves the wiper blade.

A disadvantage of the known windscreen wiper arm is its heavy weight and large dimensions.

### SUMMARY OF THE INVENTION

It is an object of the invention to obviate this disadvantage, in the sense that at minimum costs—without using complex machinery and additional tools—windscreen wiper arms having a reduced weight and reduced dimensions are proposed, while the mounting head and the arm members are interconnected in a reliable and secure manner.

Thereto, according to the invention a windscreen wiper arm mentioned in the preamble is characterized in that the the second arm member is made in one piece and has a substantially U-shaped cross-section defining a housing between a base and legs of the U-shaped cross-section, wherein the housing is arranged to accommodate at least one channel for a washing liquid and/or electricity wiring.

Hence, due to the U-shaped cross-section of the second arm member, the weight of the entire windscreen wiper arm is significantly reduced compared to conventional windscreen wiper arms. Further, the rigidity of the second arm member in longitudinal direction thereof is now increased with less material (compared to the prior art), while a “rattling” or reversal noise due to a wiping lip of the wiper blade tumbling over at each turning point of the oscillatory movement of the windscreen wiper arm, is reduced.

Finally, the channel for a washing liquid and/or electricity wiring inside the U-shaped cross-section is protected from the environment, such as snow, ice, UV-radiation from the sun, and dust.

The U-shaped cross-section extends along the entire length of the second arm member. the channel for a washing liquid and/or electricity wiring is preferably clipped or glued onto (a leg and/or a base of) the U-shaped cross-section of the second arm member. A source for the washing liquid, such as a water source/reservoir, as well as an electricity source, such as a battery, are preferably located under a bonnet of the car involved.

In a preferred embodiment of a windscreen wiper arm in accordance with the invention the first arm member has a substantially U-shaped cross-section, wherein a part of the second arm member extends between legs of the U-shaped cross-section of the first arm member. Particularly, the legs of the U-shaped cross-section of the second arm member abut the legs of the U-shaped cross-section of the first arm member at the location of their interconnection. In another preferred embodiment of a windscreen wiper arm according to the invention the first and second arm members are glued, welded or soldered together. In another preferred embodiment of a windscreen wiper arm in accordance with the invention the second arm member is made integrally from a single sheet material, wherein parts of the sheet material are folded outwardly to form the legs of the U-shaped cross-section of the second arm member.

The present second arm member is preferably made of metal. In the alternative, the second arm member is preferably made of a plastic material.

Particularly, the present second arm member in use thereof is connected to a windscreen wiper device of the “flat blade” type. Preferably, the windscreen wiper device comprises an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device (“connector”) for the windscreen wiper arm according to the invention.

In another preferred embodiment of a windscreen wiper arm according to the invention the at least one channel for a washing liquid is arranged to be connected to a spraying nozzle connected to the second arm member or the wiper blade or a connecting device interconnecting the wiper blade and the second arm member. In another preferred embodiment of a windscreen wiper arm in accordance with the invention a part of the mounting head extends between the legs of the U-shaped cross-section of the first arm member and beyond the pivot pin.

As indicated earlier, the present invention also refers to a vehicle provided with a windscreen wiper arm according to the invention. Further, the present invention also refers to a method for manufacturing a windscreen wiper arm, particularly for automobiles, comprising a mounting bead mountable on a drive shaft and a first arm member at one end thereof being pivotally connected to the mounting head by means of a pivot pin and at another end thereof being rigidly connected to a second arm member arranged to be connected to an elongated wiper blade to be placed in abutment with the windscreen to be wiped, and wherein the first and the second arm members can oscillate to-and-from between a first reversal position and a second reversal position, characterized in that the second arm member is made in one piece and has a substantially U-shaped cross-section defining a housing between a base and legs of the U-shaped cross-section, wherein the housing is arranged to accommodate at least one channel for a washing liquid and/or electricity wiring.

### THE DRAWINGS

The invention will now be explained in more detail with reference to figures illustrated in a drawing, wherein:

FIG. 1 is a schematic perspective view of a preferred embodiment of a windscreen wiper arm according to the invention (with a windscreen wiper blade); and

FIG. 2 shows schematic front and perspective views of a part of the windscreen wiper arm of FIG. 1.

### DETAILED DESCRIPTION

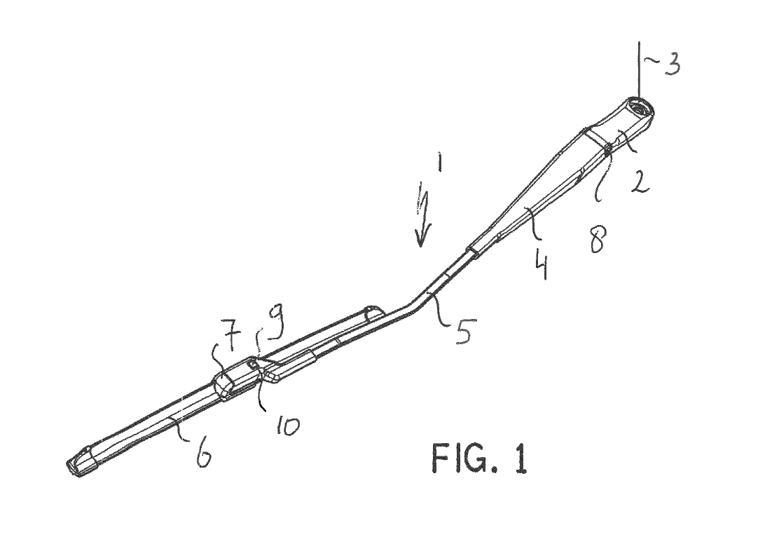

FIG. 1 shows a preferred variant of a windscreen wiper arm 1 according to the invention. As illustrated in FIG. 1, the windscreen wiper arm 1 according to the invention comprises a plastic mounting head 2 which can be fixed for rotation to a shaft 3 driven, via a mechanism not illustrated, by a small motor. The windscreen wiper arm 1 further comprises a plastic first arm member 4 supported by the mounting head 2. The windscreen wiper arm 1 further comprises a plastic second arm member 5 rigidly connected to the first arm member 4. The second arm member 5 in turn supports a schematically depicted wiper blade 6 with the help of a connecting device 7. The first arm member 4 is pivotally connected to the mounting head 2 by means of a pivot pin 8, for example in the form of a rivet. A spring (not shown) is hooked with its first end on the mounting head 2 and with its second end on to the second arm member 5 in order to ensure that the second arm member 5 and thus the wiper blade 6 connected thereto is pressed onto a windscreen to be wiped. In use, the shaft 3 rotates alternately in a clockwise and in a counter-clockwise sense carrying the mounting head 2 into rotation also, which in turn draws the first and second arm members 4,5 into rotation and by means of the connecting device 7 moves the wiper blade 6.

As illustrated, in interconnecting the connecting device 7 and the second arm member 5 use is made of a so-called “bayonet connection”, wherein a resilient tongue 9 of the connecting device 7 during a sliding movement is initially pushed inwards against a spring force and is then allowed to spring back into a correspondingly shaped hole 10 of the second arm member 5, thus snapping, that is clipping the resilient tongue 9 into the hole 10. By subsequently pushing in again the resilient tongue 8 against the spring force (as if it were a push button), the connecting device 7 together with the wiper blade 6 maybe released from the windscreen wiper arm 2. The wiper blade 6 is of the so-called “flat blade type”, wherein the wiper blade 6 includes at least one longitudinal groove, in which groove a longitudinal strip of a carrier element is disposed in order to bias the wiper blade 6.

As illustrated, the first arm member 4 has a substantially U-shaped cross-section near the pivot pin 6 comprising legs or sidewalk, wherein the sidewalls extend between a part of the mounting head 2 and beyond the pivot pin 6. the part of the mounting head 2 is provided with opposite surfaces. The first arm member 4 is pivotally connected to the mounting head 2 by means of the pivot pin 8, wherein the first arm member 4 can be pivoted between a wiping position (or “working position”), wherein the first arm member 4 extends parallel to a windscreen to be wiped, and an elevated or upright position (or “service position”), wherein the first arm member 4 and/or a windscreen wiper blade 6 to be attached to the second arm member 5 can be repaired or replaced.

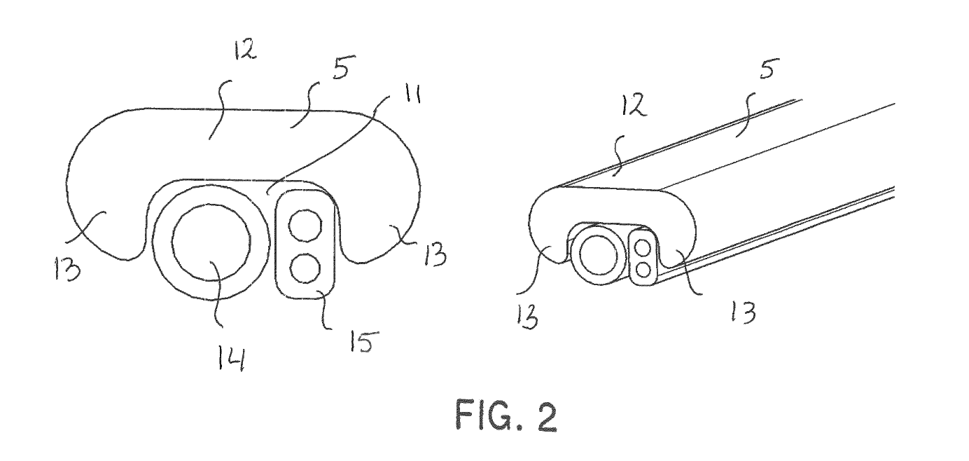

With reference to FIG. 2, the second arm member 5 is made in one piece and has a substantially U-shaped cross-section defining a housing 11 between a base 12 and legs 13 of the U-shaped cross-section. the housing 11 is arranged to accommodate a channel 14 for a washing liquid and a channel 15 for electricity wires. As depicted, a part of the second arm member 5 extend between inside the U-shaped cross-section of the first arm member 4, wherein the legs 13 of the U-shaped cross-section of the second arm member 5 abut the legs of the U-shaped cross-section of the first arm member 4 at the location of their interconnection. In this case the first and second arm members 4,5 are welded together.

The invention is not restricted to the embodiment shown, but also extends to other preferred embodiments falling within the scope of the appended claims.

1. A windscreen wiper arm, comprising a mounting head mountable on a drive shaft and a first arm member at one end thereof being pivotally connected to the mounting head by means of a pivot pin and at another end thereof being rigidly connected to a second arm member arranged to be connected to an elongated wiper blade to Be placed in abutment with said windscreen to be wiped, and wherein said first and said second arm members can oscillate to-and-from between a first reversal position and a second reversal position, wherein said second arm member is made in one piece and has a substantially U-shaped cross-section defining a housing between a base and legs of said U-shaped cross-section, wherein said housing is arranged to accommodate at least one channel for a washing liquid and/or electricity wiring.

2. The windscreen wiper arm according to claim 1, wherein said first arm member has a substantially U-shaped cross-section, and wherein a part of said second arm member extends between legs of said U-shaped cross-section of said first arm member.

3. The windscreen wiper arm according to claim 2, wherein said legs of said U-shaped cross-section of said second arm member abut said legs of said U-shaped cross-section of said first arm member at the location of their interconnection.

4. the windscreen wiper arm according to claim 2, wherein said first and second arm members are glued, welded or soldered together.

5. The windscreen wiper arm according to claim 1, wherein said second arm member is made integrally from a single sheet material, and wherein parts of said sheet material are folded outwardly to form said legs of said U-shaped cross-section of said second arm member.

6. The windscreen wiper arm according to claim 1, wherein said at least one channel for a washing liquid is arranged to be connected to a spraying nozzle connected to said second arm member or said wiper blade or a connecting device interconnecting said wiper blade and said second arm member

7. The windscreen wiper arm according to claim 1, wherein a part of said mounting head extends between said legs of said U-shaped cross-section of said first arm member and beyond said pivot pin.

8. A vehicle provided with a windscreen wiper arm according to claim 1.

9. A method for manufacturing a windscreen wiper arm, comprising a mounting head mountable on a drive shaft and a first arm member at one end thereof being pivotally connected to the mounting head by means of a pivot pin and at another end thereof being rigidly connected to a second arm member arranged to be connected to an elongated wiper blade to be placed in abutment with said windscreen to be wiped, and wherein said first and said second arm members can oscillate to-and-from between a first reversal position and a second reversal position, wherein said second arm member is made in one piece and has a substantially U-shaped cross-section defining a housing between a base and legs of said U-shaped cross-section, wherein said housing is arranged to accommodate at least one channel for a washing liquid and/or electricity wiring.
